(19) United States
(12) Patent Application Publication
(10) Pub. No.: US 2007/0175857 A1
(43) Pub. Date: Aug. 2, 2007

(54) Decorative surface treatment for metals

(76) Inventor: Bruce T. Boone, Roswell, GA (US)

Correspondence Address: BRUCE T. BOONE, 4550 BASTION DRIVE, ROSWELL, GA, 30075, US

(21) Appl. No.: 11/656,867

(22) Filed: Jan. 23, 2007

Related U.S. Application Data
(63) Continuation of application No. 60/763,217, filed on Jan. 30, 2006.

(51) Int. Cl. B44C 1/22; C03C 15/00

(52) U.S. Cl. 216/32; 216/65

(57) ABSTRACT

A decorative surface treatment of hardenable metals to achieve a three dimensional textured surface with the appearance of mokume gane or Damascus steel. The annealed surface of the metal is selectively hardened by a laser in zones next to unhardened areas. The unhardened areas are selectively eaten away by abrasives in a way that allows deep texture relief.

### CROSS REFERENCE TO RELATED APPLICATIONS

This application claims the benefit of the provisional patent Ser. No. 60/763,217, filed Jan. 30, 2006 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to creating a decorative surface texture on hardenable metals.

2. Prior Art

Jewelry items such as finger rings have been traditionally manufactured using precious metals such as gold or platinum alone or in alloys. The alloys are generally homogeneous, thus are comprised of a single color. An ancient metal forming technique called mokume gane combines dissimilar metals below the melting point of the constituent metals, and it allows the creation of patterns of differing shades or colors within the metal. The patterns are formed without the use of solder and without fully melting the metals together. This diffusion bonding technique takes very controlled conditions in order to work. The metals must be scrupulously cleaned, be heated in an oxygen free atmosphere at a very controlled time and temperature, and the metals must be pressed together during the heating with a large amount of force so that atoms on the surface of each metal mix with those in adjacent layers of dissimilar metal. The resulting billet of combined metals must then be forged, repeatedly annealed, and further worked to create the mokume gane's characteristic patterns. Extreme care in constant annealing must be taken to be sure the layers do not delaminate in the forging process. Only certain metals can be joined in this way, and the patterns possible are dictated by the physical constraints of the metals. The process is very involved, and is reserved for use by very skilled craftsmen. The resulting jewelry or decorative work for knife handles, pens, or other items commands a premium in price because of the expense of the materials and large amount of labor involved in making them.

Damascus steel is another product of an ancient metal working technique made in a similar way to mokume gane in that patterns are made by folding over layers of metal and altering the carbon composition for lighter and darker areas. It is done while the metal is hot and involves the use of high tonnage presses or forging by hand. Like mokume gane, it is the product of a skilled artisan, and commands a high price when used in decorative pieces like knives or pens. The Damascus process can be done with different alloys of stainless steel, as taught by U.S. Pat. No. 5,185,790 Method Relating to the Manufacture of a Composite Metal Product by Billgren, et al., or in titanium as taught by U.S. Pat. No. 6,857,558 Metal Lamination Method and Structure by Ferry et al. There are preceding versions of the process such as U.S. Pat. No. 4,881,430 and U.S. Pat. No. 4,399,611, which use different metals, high heat, and forging of materials to make decorative patterns in metal.

More recently, finger rings made from higher strength materials such as titanium and stainless steel have become popular. These rings are typically turned on computer controlled lathes from barstock instead of cast like the precious metals typically are.

Rings of high strength materials are often visually enhanced by the addition of precious metal inlays, including inlays of expensive mokume gane materials. The inlay materials normally start as flat wire and are hammered or pressed into grooves in the ring surface. The material is usually soldered, brazed, or welded at the starting and ending point. The price of the rings reflects the expensive inlay material and labor involved to make them. The mokume gane inlay materials are generally softer than the metal of the base metal. Some metals used in mokume gane or Damascus steel are also chemically reactive, so can cause allergic reactions or discolor over time. Because mokume gane is made from different metals, some galvanic reaction can occur, so the metals may get eaten away over time, especially if the consumer has acidic sweat.

Surface treatments of metals such as texturing of steel used in injection molds has typically been done by photochemical etching. This process is somewhat like developing film. It usually involves the use of clear glass or plastic plates with opaque artwork, where the artwork blocks light shown onto the metal that has been treated with a photosensitive material. The photo resist material blocks the effect of acid as the pattern is selectively etched into the steel. Some materials such as titanium can only be done using extremely dangerous acids such as hydrofluoric acid. Such acids can have deadly fumes or cause serious burns.

A similar technique typically used on injection molds involves masking off areas and beadblasting texture in exposed areas. The masking is time consuming and difficult to apply in some cases. Masking done by this technique works best on flat areas where there is enough room for the adhesive to stick well. It is less effective on tightly curves surfaces, or in small patterns, where the individual pieces can get more easily moved by the high pressure jet of the beadblaster.

Another surface treatment that is widely used in industry is the selective eating away of material by laser. This process utilizes a laser with enough power to vaporize the metal. Such lasers are typically very large, use a lot of power, and are extremely expensive to own and operate.

Another surface treatment that is currently available is selective laser hardening. This process can harden only a small area of a larger cast piece, so it can be a cost effective way to keep from having to harden the entire part. Such treatment hardens the metal but doesn't change the appearance of the metal.

Because the high strength metals are essentially gray in color, using a surface technique that would add texture in defined patterns and have the appearance of mokume gane or Damascus steel would add a lot of perceived value to an item. Making such patterns without having to go through the numerous steps and complexities of producing mokume gane or Damascus billet by precise heating, compressing, and forging the multiple metals into patterns would have a manufacturing advantage. It would also be an advantage to not have to use high powered metal cutting lasers, inert atmospheres, specially shaped masking material, extremely strong acid, or beadblasting to create the patterns.

In my invention, the material to be patterned must be a hardenable material such as steel, stainless steel, or titanium. These materials are generally found in objects such as knife blades and handles, wedding rings and other jewelry, pens, and other objects of art. A relatively low powered laser such as those typically used for engraving of woods and plastics is used to selectively harden the surface in the desired pattern. Such lasers are typically CO2 lasers, which operate in the far infrared, and a power in the 130 watt range is sufficient. The concentrated beam intensity causes hardening of the material by heating it rapidly in only a small spot, so that once the beam is moved away, the surrounding metal cools the small heat-affected area rapidly enough to cause the atoms to freeze in place, thus hardening the material. By following computer generated artwork like a plotter, the laser can create harder areas and unaffected softer areas in the material side by side. The surface may be uncoated when exposed to the laser beam, or it may be coated with a substance to absorb more laser radiation without reflecting as much back to the laser. When the surface has been processed by laser in the desired pattern, it is then exposed to a finishing wheel, wire wheel, or other means of abrading the softer material away. The harder laser processed material stays standing without being abraded away. In the case of titanium, the two hardness areas will anodize at slightly different rates, so a color variation between laser processed and underlying areas is possible. It is also possible to coat the surface of the material with a ceramic prior to firing. The ceramic is selectively fired by the laser, and it remains non-reactive and hard when the surface is abraded. This ceramic stays in the pores of the metal even after abrasion, and gives slightly more color contrast between upper and lower areas. When the laser hardened materials are abraded, the unhardened lower lying areas tend to polish more than the hardened areas, which remain higher and more diffuse. The effect is a two toned surface that closely mimics Damascus steel or mokume gane when produced from a white gold and sterling silver mixture.

Another advantage of the invention technique allows a situation where the hardenable base metal has an inlay of a softer non-hardenable material, such as a wedding ring with a silver inlay. The inlay is hammered into the ring first, and the laser hardening pattern is applied to the whole ring. Because the laser does not harden the inlay, the inlay metal is left unpatterned. No special masking or changes in artwork is necessary to achieve this effect. This effect is not easily achievable by the traditional methods because the softer inlay material would disrupt the mokume gane or Damascus steel it was inlaid into.

### OBJECTS AND ADVANTAGES

Accordingly, it is the object of this invention to:

(a) enable a surface treatment of a single high strength material to have the look and texture of multiple metal mokume gane or Damascus steel;

(b) enable a look and texture of mokume gane or Damascus steel while using a single metal, so galvanic reaction is not an issue;

(c) enable a look and texture of mokume gane while using a harder metal than is typically used;

(d) enable a look and texture of mokume gane or Damascus steel while using a metal that is less chemically reactive than those typically used;

(e) provide the means of producing mokume gane or Damascus steel patterns without the need for special kilns, or accurate temperature control normally required;

(f) provide the means of producing mokume gane or Damascus steel patterns without the need of a special atmosphere devoid of oxygen normally required;

(g) provide the means of producing mokume gane or Damascus steel patterns without the need for forging and complex manipulation of the billet normally required;

(h) provide the means of producing mokume gane or Damascus steel patterns without the physical constraints of the metals being joined;

(i) provide the means of producing the patterns without the need for dangerous acids;

(j) provide the means of texturing the surface without the need for masking off the materials, the mask movement issues, and the labor needed to beadblast the materials;

(k) provide means of texturing the surface without the need for expensive metal vaporizing lasers;

(l) provide the means for texturing cylindrical or curved surfaces without the need for complex masking and exposure means.

(m) provide means for being able to texture an entire surface without the need to softer inlay mokume gane materials into a harder material.

### SUMMARY

It is the object of the present invention to overcome the disadvantages of the prior art and provide a means to simulate the look and texture of Damascus steel or mokume gane on high strength materials, and allow manufacture by a more streamlined method.

### DRAWINGS—FIGURES

FIG. 1 is a schematic view of a ring during the laser hardening process.

FIG. 2 is a perspective view of a ring's softer areas being abraded away.

FIG. 3 is a perspective view of a ring after the abrasive process.

FIG. 4 is a sectional view of a ring after the abrasive process.

### DRAWINGS—REFERENCE NUMERALS

10 computer

12 laser

14 laser beam

16 focusing lens

18 focal point

20 ring to be hardened

22 rotary axis

24 linear axis

26 hardened areas

28 unhardened areas

30 finishing wheel

32 mandrel

34 treated ring

36 motor

### DETAILED DESCRIPTION

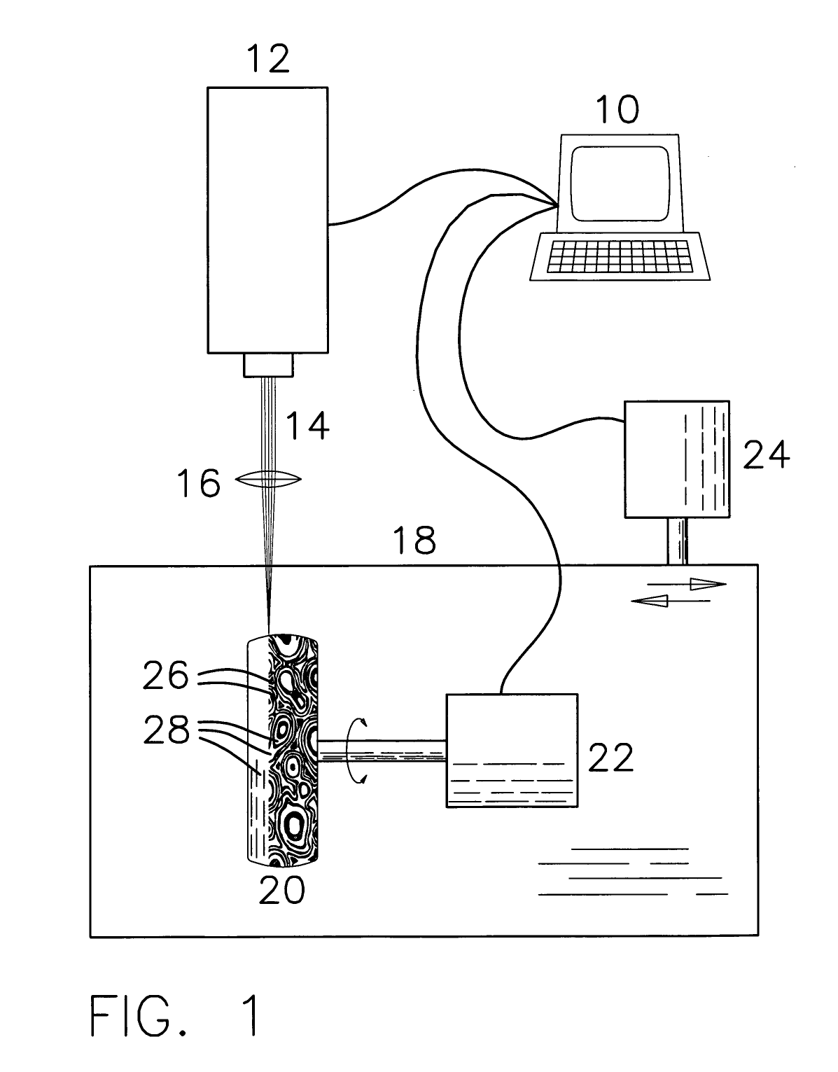

FIG. 1. is a schematic view of a ring during laser hardening. The part to be hardened, such as the ring 20 is previously made from a hardenable material such as titanium, stainless steel, or carbon steel, and is in an annealed state. A computer 10 drives a laser 12 in concert with a rotary axis 22 and a linear axis 24 such that the output can effectively cover any location on the outer surface of ring 20. If flat objects are to be textured, the laser follows an XY path instead of using a rotary axis. The laser beam 14 passes through focusing lens 16 to a focal point 18 of approximately 0.13 mm diameter on the peripheral surface of the part to be hardened 20. The laser can be used in vector mode, where it linearly follows the paths of lines and arcs generated in a CAD program, or it can be used in raster mode, where the laser shuttles back and forth in the linear axis 24, turning on and off in response to black or white bits in a single row of the artwork, before advancing to the next row by the rotary axis 22. Raster mode is used where more complex artwork is desired, such as that depicting most patterns of Damascus steel or mokume gane. A type of laser commonly used for engraving of wood and plastics can be used, and it is typically used on its highest wattage setting and a very slow feedrate to maximize the surface hardening ability for the laser. Exact settings are not necessary. When the laser heats the surface and it rapidly air cools, it creates hardened areas 26 among the unheated and unhardened areas 28. Because the wattage of typical lasers used are below that needed to melt the metal, the two areas 26 and 28 look visually similar. The hardened areas 26 are shown shaded for clarity but will not be visible on a part.

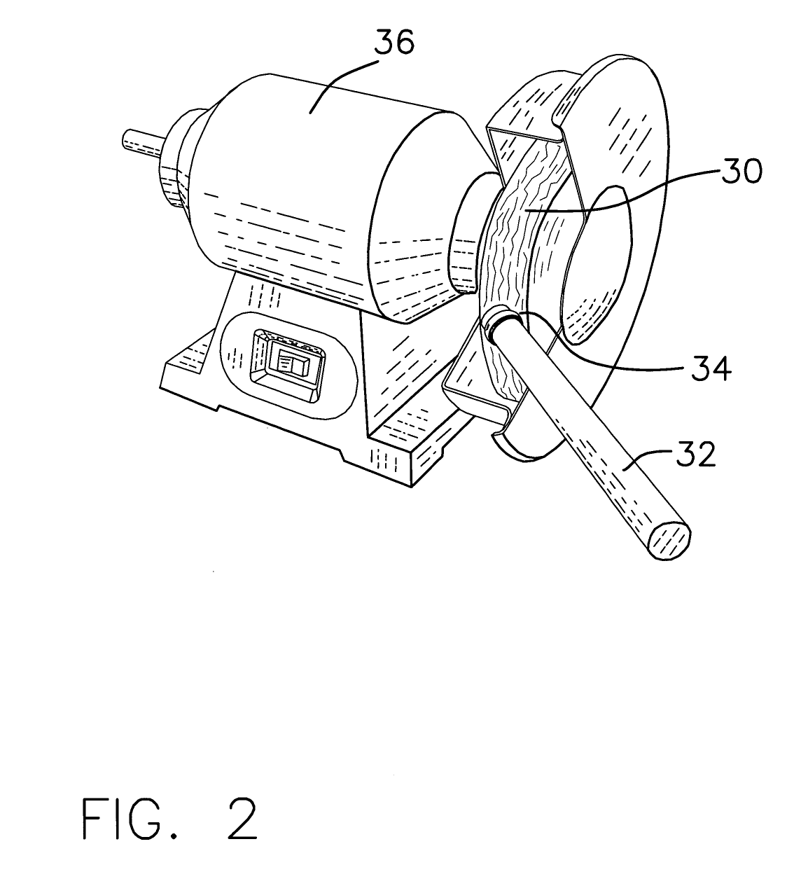

FIG. 2. is a perspective view of a ring's softer areas being abraded away. Since the selective hardening process is not yet visually evident on the surface of the part, it is necessary to abrade the surface in order to get a differential between hardened and unhardened areas. A motor 36 driven finishing wheel 30 composed of nonwoven plastics imbedded with abrasives works well. Other possible means of abrasion include flap wheels, beadblasting, wire wheels, or similar means. The entire surface is run under the wheel without regard for orientation or direction. A mandrel 32 facilitates holding a ring 20, but other means of workholding are possible. When the abrasive process takes place, the softer areas that were not hardened by the laser are selectively eaten away more than the hardened areas. This creates the three dimensional texture unique to mokume gane or Damascus steel. Different combinations of abrasive techniques give differing results with respect to reflectivity, color, and texture of the surfaces.

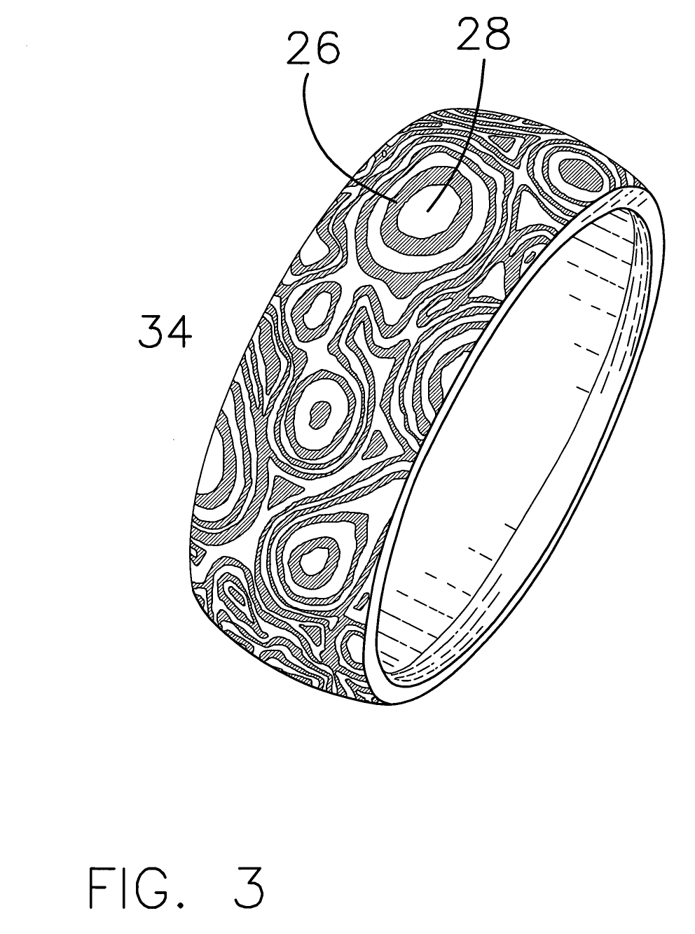

FIG. 3. is a perspective view of a ring after the abrasive process. Hardened areas 26 stand up higher than the original unhardened surface areas 28, which are abraded away. The surface can take on the look of mokume gane patterns or Damascus steel.

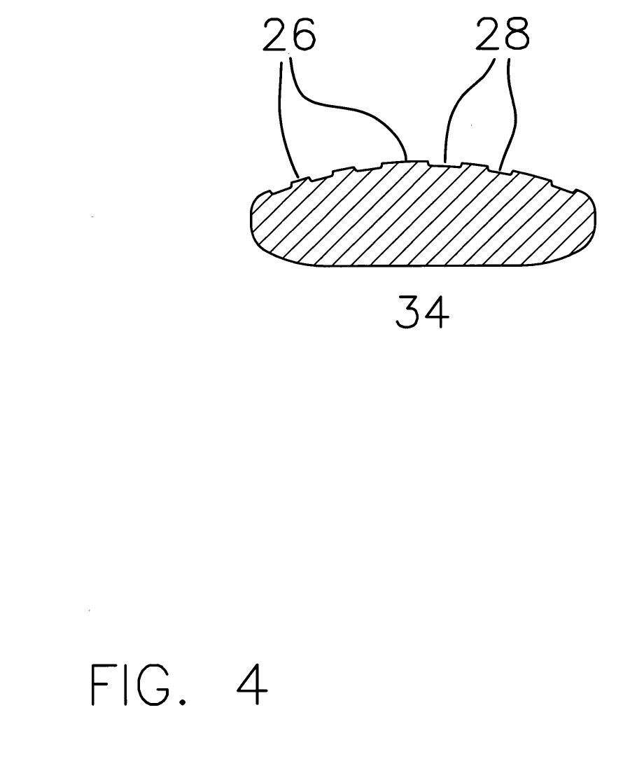

FIG. 4. is a close up view of a lateral cross sectional view of a treated ring 34. Hardened areas 26 stand to the height of the original surface, while unhardened areas 28 are abraded to a level below that of the original surface.

I claim:

1. A decorative surface treatment for metals comprising:
(a) a single hardenable metal such as titanium, stainless steel, or carbon steel in an annealed state,
(b) selectively heating the surface of said metal with a laser to create zones of hardened and unhardened material,
(c) and means for selectively abrading unhardened portions of the metal surface away to create a three dimensional textured surface with the appearance of Damascus steel or mokume gane.

2. The treatment of a metal in claim 1 wherein said metal is titanium.

3. The treatment of the metal in claim 2 wherein the titanium is anodized, causing the hardened and unhardened area to contrast in color.

4. The treatment of a metal in claim 1 wherein said material is coated with ceramic prior to laser hardening to enhance contrast.

5. The treatment of a metal in claim 1 wherein said metal gets an inlay of a softer precious metal such as gold, silver, or platinum, and said inlay is unaffected by the laser hardening process.
